(19) United States
(12) Patent Application Publication
(10) Pub. No.: US 2008/0127810 A1
(43) Pub. Date: Jun. 5, 2008

(54) Morpheus music notation devices and system

(76) Inventor: Mark Patrick Egan, Dublin (GB)

Correspondence Address: OUR PAL ASIJA;ASIJA HOUSE, 7 WOONSOCKET AVENUE, SHELTON, CT, 06484-5536, US

(21) Appl. No.: 12/002,964

(22) Filed: Dec. 18, 2007

Related U.S. Application Data
(63) Continuation-in-part of application No. 11/016,438, filed on Dec. 20, 2004, now Pat. No. 7,241,945.

(51) Int. Cl. G09B 15/02

(52) U.S. Cl. 84/483.2

(57) ABSTRACT

Devices, methods and system for a morpheus music notation system adapted for key, string, wind and percussion instruments for ease of teaching and learning music intuitively. Intuitive morpheus music notation system creates a simple environment revolving around numbers, letters and specific technical devices to enable people of all ages of any race or colour whether they are with sight or without to learn any musical instrument. The idea relates to all instruments, wind, brass, stringed, bowed, percussion, keyboard, unusual global instruments, organ & electronic instruments. Also relates to a set of hand movements performed by conductors of music.

### RELATED APPLICATION

This application is a Continuation-in-Part application to U.S. Ser. No. 11/016,438 filed Dec. 20, 2004, which is expressly incorporated in this application

### BACKGROUND

This invention relates to the art of teaching and learning of music through a simplified music notation system by means of technical & mechanical devices. Even more particularly it relates to a morpheus music notation system comprising of specific technical devices adapted for key, string, wind and percussion instruments for ease of teaching and learning music intuitively. Unlike prior art bottom-up notation systems, the morpheus system is top down, which is intuitive and even conventional in the western languages.

### THE PROBLEM

All musical instruments available today pivot around the audio spectrum of the 88 keys on a classical piano. From a primary age children systematically learn the alphabet and to count to 100. The music sheet created is comprised of two clef structures referred to as the Leda Clef (Left Hand) & the Rama Clef (Right Hand). Both the Leda & Rama Clefs contain five lines, as is the case in traditional music Clefs.

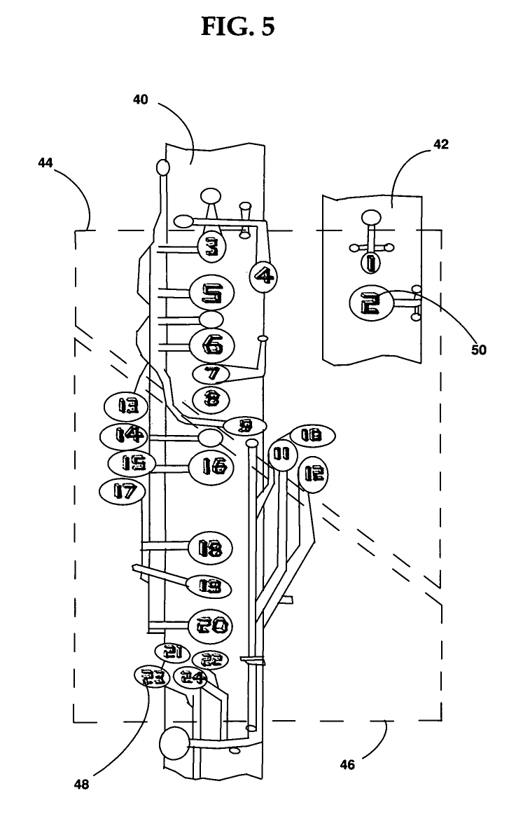

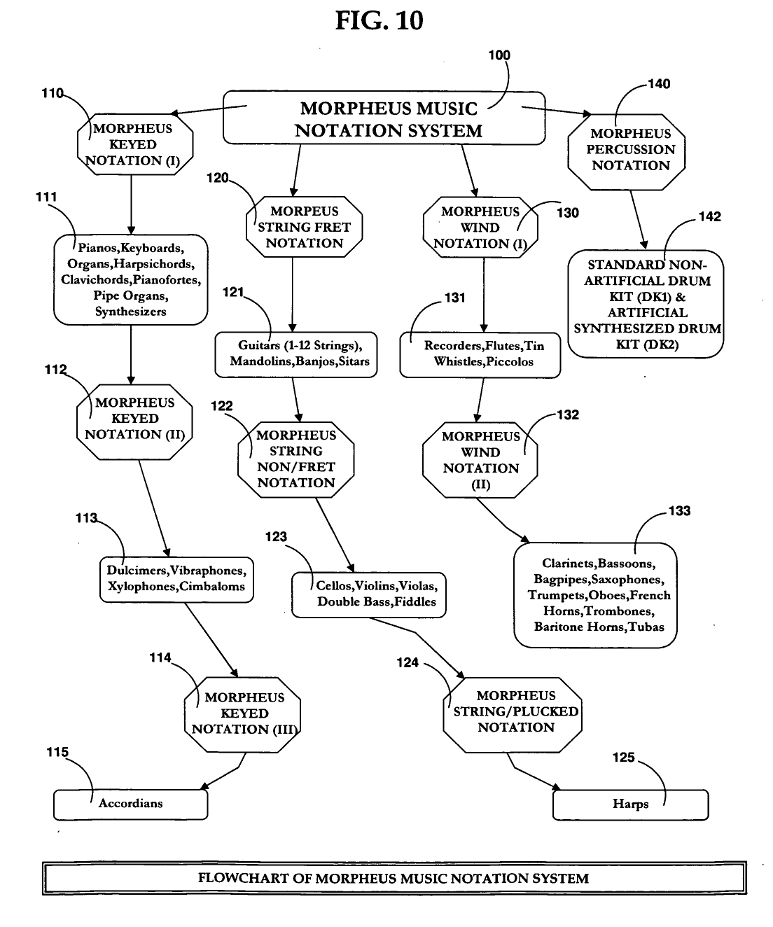

The concept of this new teaching device(s) for all instruments listed within the Flowchart represented in FIG. 10, which is same as FIG. 5 of the Parent application Ser. No. U.S. 11/016,438 and comprises of the following three parts:

a) Morpheus Finger Ring Configuration Device

b) Morpheus Numeric Coded Etched/Embossed Instrument Device

c) Morpheus Notation Music Sheet

The Morpheus Finger Ring Configuration Device is a fundamental part of the teaching device created using the embodiment of the parent application Ser. No. 11,016,438. The fingers are assigned letters i.e., A, B, C, D, E, (Left Hand) & F, G, H, I, J (Right Hand) which are then labelled, embossed or etched onto specifically manufactured plastic or silicone finger rings. These letters are then applied to both these clef structures and the use of the Butterfly Effect in regards to how humans read literature in general is then functional.

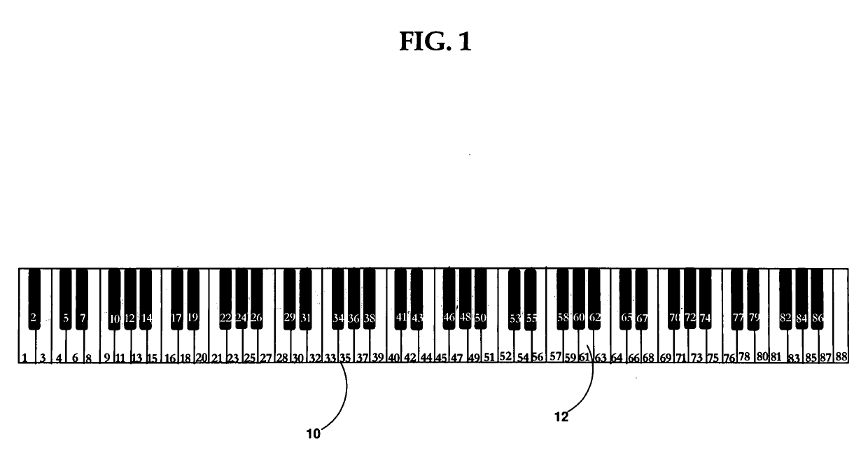

The Morpheus Numeric Coded Etched/Embossed Instrument Device is then created whereby the numbers of the exact keys as indicated in the Classical Piano Layout represented in FIG. 1 (Same as FIG. 1 of Parent application Ser. No. U.S. 11/016,438) are etched or embossed onto each key of the relevant Instrument. For example, the instrument device specifically created for the classical piano would have the exact numeric values from 1 to 88 labelled, embossed or etched onto the classical piano keys by laser or other technical process.

The Morpheus Notation Music Sheets are developed which are directly related to the embodiments of the other two device mechanisms i.e., each alpha character from the finger ring configuration device is aligned to the lines within the music sheet structure and each numeric value from the numeric etched/embossed instrument device are applied to the lines on this music sheet structure. Using the notation on the music sheet the student recognises the numbers on the lines of the Clefs in reference to the piano and uses the correct finger co-ordination by way of the finger ring configuration device with the correct note no matter how complex the music is. The teaching device and method also leaves the students with the option that they never have to learn any traditional musical theory of any level.

The morpheus notation system and devices of this invention are adaptable to every single musical instrument (including all key, string, wind and percussion instruments) within the audio spectrum and makes it possible for children, adults, elderly and the blind to learn a musical instrument.

### SUMMARY

This invention comprises methods, devices and system for learning and teaching key, string, wind and percussion musical instruments through a simplified morpheus music notation system comprising a set device containing a Finger Ring Configuration Device, Numeric Coded Etched/Embossed Instrument Device and a Specific Music Notation Sheet.

### PRIOR ART

A preliminary prior art patent search was conducted. Furthermore the applicant is intimately familiar with the prior art. Since the morpheus method was developed there have been many examples of various methods to teach music in order to make it more user friendly to the general population and are explained in detail within the parent application Ser. No. U.S. 11/016,438.

Within all previous methods to teach music, the one thing they all have in common, due to the wide scope and technical complexities of standard music notation, is that the student can only go so far with the specific method and the necessity to learn traditional musical theory is imperative in order to progress. At any rate none of the prior art devices known to the applicant or his attorney disclose the EXACT embodiment of this inventor that constitutes a simple, elegant, secure, flexible, convenient, affordable means for this system.

### OBJECTIVES

Unfortunately none of the prior art devices singly or even in combination provide for all of the objectives as established by the inventor for this system as enumerated below.

1. It is an objective of this invention to provide methods, devices and system for learning and teaching of key, string, wind and percussion musical instruments through a simplified morpheus music notation system.

2. Another objective of this invention is by using the fundamental concept of the Morpheus Music Notation teaching device, comprising of an instrument with its exact numeric values directly related to the aforementioned Classical Piano layout, embossed or labeled onto the instrument and also comprising of special manufactured finger rings with the exact alpha characters as aforementioned namely A, B, C, D, E, F, G, H, I and J labeled or embossed on each of these finger rings is applicable. This definitive, specific and technical designation that makes up the device is the fundamental concept that maybe used across the spectrum of all instruments. Hence devices for all other instruments are developed from the original fundamental concept device for the Classical Piano.

3. Another objective of this invention is to utilize a revolutionary music notation system that enables children, adults, elderly & the blind to learn any musical instrument without the prior knowledge or prerequisite to learn the traditional and prior art music notation theory.

4. Another objective behind this new type of notation is that people learn instantly exactly what fingers to use in the butterfly effect when taking up an instrument and the window of creativity continues because of no requirement to ever learn standard musical theory of any level.

5. Another objective of the invention is to provide a structure that is simple to follow where the exact numbers of the keys are represented on both clefs with the correct fingering laid out. There is no need for the teacher/tutor to re-organise the fingering of the keyboard every time a new song needs to be learned.

The finger ring configuration device in harmony with the novel manufacture process applied to the instrument solves this problem where the Rama Clef (Right Hand) contains F, G, H, I, J which starts at the top-down which is instantly recognisable in regards to reading from the top-down. The idea centres around the depiction of a sort of butterfly effect across both clefs.

6. Another object of the invention is to provide a teaching device or instrument and music sheet where there is no limit to the amount of octaves to be represented on both clefs which is so important when students begin to learn classical piano music. Chord progressions, complex piano solos requiring the full length of an eighty-eight note classical piano using both hands and the ability of the left hand operating at the melody section in some cases of classical music is totally manageable.

7. Another object of the invention is to provide a teaching device or instrument and music sheet where the invention will become so useful to music publishing companies that the notation will appear for popular songs. The idea of a student about to begin playing the instrument will search consistently in the stores for this unsophisticated method. This leads to what I think should be the initial goal of anyone learning an instrument ‘to learn the instrument without the help of tutors or teachers’. This is where I believe the creativity involved in playing an instrument comes into play. The student is not under the control of any teacher/tutor and because the method is so easy adults and the elderly will begin to pick up the idea of playing an instrument.

8. Another object of the invention is to provide a teaching device or instrument and music sheet where the full audio spectrum of all instruments revolves within the eighty-eight notes of a piano hence all the notes can easily be represented on both clefs in the correct fingering method instantly.

9. Another object of the invention is to provide a teaching device or instrument and music sheet where the student is instantly learning the fingering co-ordination involved in playing the keys on the piano.

This develops their mind, which leads to experimentation in playing the instrument. No strict line on how far the student can progress and because of the ease of use with the Morpheus Notation method and devices, their ability develops at a very fast pace.

10. Another object of the invention is to provide a teaching device or instrument and music sheet where the student never requires the need to learn traditional musical theory of any level. I believe, this is the only way that new ideas will develop in a students mind where traditional musical theory requires the student to follow a strict set of rules i.e., that some notes, chords cannot be played over each other. With no boundaries using the Morpheus Notation and device mechanism the mind will develop new ideas in playing an instrument in a sense being able to step outside of the norm.

11. Another object of the invention is to provide a teaching device, instrument and music sheet where there is no use of sharps/flats/naturals symbols in Morpheus Notation. The black keys in the notation with its numeric value are indicated in bold font and the standard white notes in normal font. This helps the student differentiate instantly the black notes from the white notes i.e., 41=C3#; 40=C3.

12. Another object of the invention is to provide a teaching device, instrument and music sheet where the Rama Clef on the Morpheus Notation depicts exactly how humans read with the brain i.e., top-down. No complications where the notation adapts to people instead of the reverse.

13. Another object of the invention is to provide a teaching device, instrument and music sheet where the method is adaptable to every instrument in the world today and to instruments that have not even been invented as of yet because the base or origin of the notation revolves around the scale of the music audible spectrum that covers the human hearing range and this base is always to be used to create each type of technical teaching device whatever the instrument.

14. Another object of the invention is to provide a teaching device, instrument and music sheet where the method increases the hearing ability of the student and also creates unknowingly to the student a type of internal tempo/sync clock within the brain which leads to unprecedented natural rhythm.

15. Another object of the invention is to provide a teaching device, instrument and music sheet where adults will be encouraged to learn a musical instrument in a simple environment which otherwise under present methods of teaching instruments to people prevents them from doing so.

16. Another objective of this invention is that its method and devices be versatile enough to include all types of musical instruments such as wind instruments, brass instruments, stringed, bowed, percussion, keyboard, organ, electronic and the global collection of unusual instruments could benefit from this new type of device manufacture and notation. The idea can also be applied to a laid out system of movements from a conductor of music. When fully trained the qualified conductor can bring his own method into play i.e., creativity. Even the trainee conductors could be taught the initial system in a simple way where different hand movements assigned a specific number create various expressions on the music. These specifically assigned numbers could then be placed on the music sheet to determine the expressional or emotional changes taking place, while the music is being played by the orchestra.

16. Another objective of this invention is that it obviates music tutors, teachers etc., such that self-teaching children, adults, elderly etc., an instrument is practical.

17. Another objective of this invention is that even the blind can self teach a musical instrument in conjunction with Braille. However, because of the simplicity of the teaching device and music sheet, manufacturers of instruments and music publishers will be given the option that the non-braille alpha characters namely A, B, C, D, E, F, G, H, I, J and numeric characters namely and not limited to values between 1-88 can be embossed, etched onto the relevant instrument.

This specific device can then be used equally by people with sight or without. This breakthrough in a new and technical teaching device would harmonise a society of musicians, whether they be with sight or without, learning instruments in tandem with each other side by side.

18. Another objective of this invention is that it can be popularized and maintained with ease.

19. Another objective of this invention is to make it suitable for users of a broad range of ages and situations.

20. Another objective of this invention is that its use requires no additional training or skill on the part of the student or the teacher.

21. Another objective of this invention is that it be capable of multiple uses in music.

22. Another objective of this invention is that it uses little or no additional energy except the normal human energy of the user.

23. Another objective of this invention is that the invention be intuitive user friendly

24. Another objective of this invention is that it be environmentally friendly and use materials which are harmonious with the environment

25. Another objective of this invention is that it be safe in normal as well as unusual situations.

26. Another objective of this invention is that the devices and components of its system be strong, long lasting and made from durable materials.

27. Another objective of this invention is that it meets all international federal, state, local and other private conventions, standards guidelines, regulations and recommendations with respect to safety, environment, and energy consumption.

Other objectives of this invention reside in its simplicity, elegance of design, ease of manufacture, service and use and even aesthetics as will become apparent from the following brief description of the drawings and the detailed description of the concept embodiment.

Unfortunately none of the prior art devices singly or even in combination provides all of the features established by the inventor for this system as enumerated below.

a) Affordable and Cost effective

c) Easy to learn and teach

d) Intuitive

e) User Friendly

e) Easy to manufacture, use and maintain.

f) Suitable for people of all ages and gender in all types of situations.

g) Easily adaptable for other uses

### BRIEF DESCRIPTION OF THE DRAWINGS

These objects and features of the invention shall now be described in relationship to the following drawings.

a) FIG. 1 shows a classical piano layout 10 and the numeric value of each key

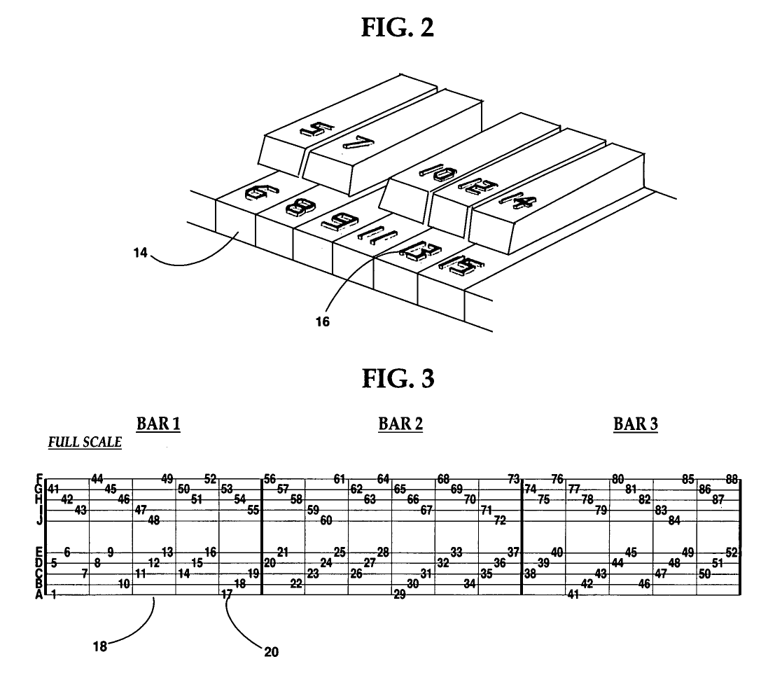

b) FIG. 2 shows a morpheus music sheet vis-à-vis two standard scales.

b) FIG. 3 shows a teaching device consisting of the specific keys on a keyboard instrument being embossed or etched with the exact but not limited to numeric values from 1-88 using a technical process such as a laser or other means.

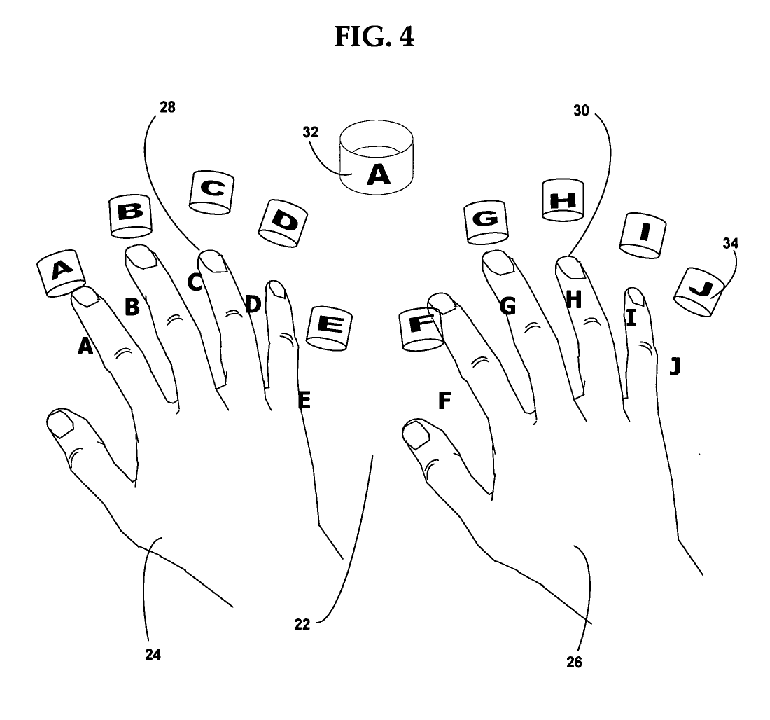

c) FIG. 4 shows a specific finger ring configuration device to be used as a fundamental device for all instruments categorised within the flowchart of FIG. 10

d) FIG. 5 shows a specific teaching device for the Clarinet.

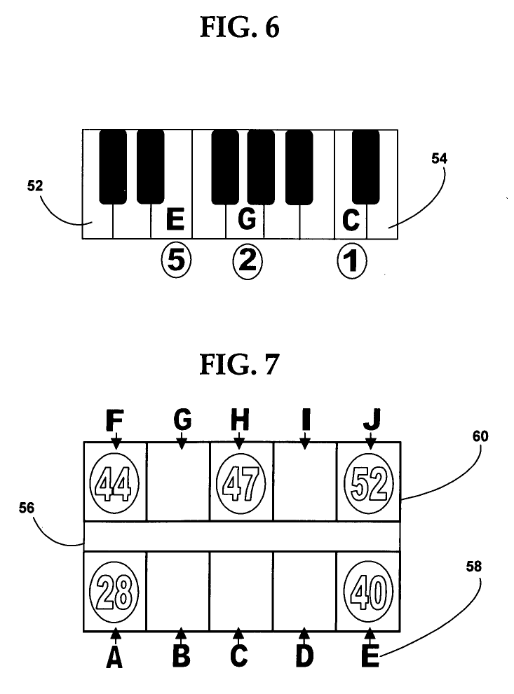

e) FIG. 6 shows a Conventional Chord Chart for Key Instrument.

f) FIG. 7 shows a Morpheus Chord Chart for Key Instrument.

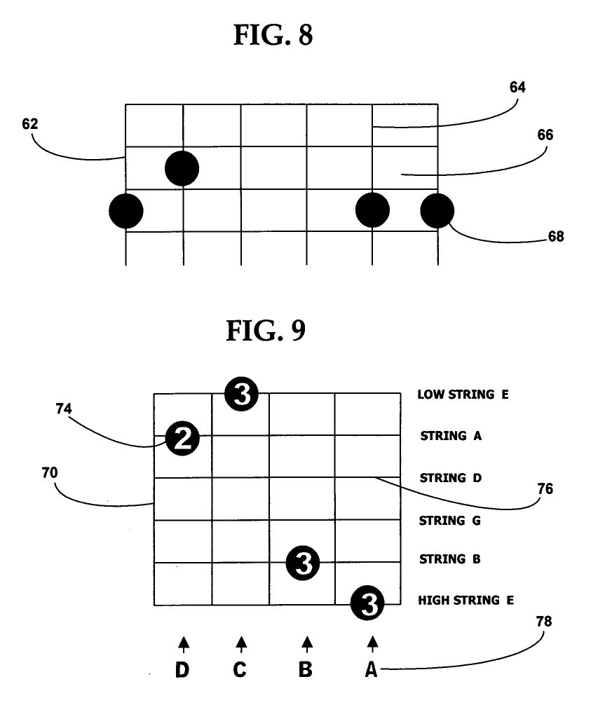

f) FIG. 8 shows a Conventional Chord Chart for String Instrument.

g) FIG. 9 shows a Morpheus Chord Chart for String Instrument.

h) FIG. 10 is a flow-chart of the Morpheus music notation system.

### DETAILED DESCRIPTION OF THE BEST MODE PREFERRED EMBODIMENT

The foregoing and other objects, devices, aspects, uses and advantages of the present invention will be more fully understood from the following detailed description when viewed in conjunction with the accompanying drawings in which FIG. 1 shows a classical piano layout 10 and the numeric value of each key 12.

FIG. 2 shows the fundamental device 14 which all other instrument devices fall into via the Classical Piano layout 10. The classical piano is assigned its exact numeric value with relevance to the classical piano layout 10 of FIG. 1. These numeric values are then etched or embossed 16 onto each key from 1-88. Thus what is created is a new instrument teaching device with embossed letters on each key.

FIG. 3 represents an example of the music sheet format 18 which is used by the user to instruct him/her which key on the classical piano is to be played. All keys on the piano i.e., from 1-88 can be displayed 20, thus any piece of music whether it be from beginner to virtuoso can be represented, without the need of standard notational symbols to be placed anywhere on the sheet.

FIG. 4 is the fundamental teaching device that will be used in the creation of all devices for other instruments. This backbone to the Morpheus Music Notation teaching device is referred to as the Finger Ring Configuration Device 22. Each finger of the left hand 24 is assigned an alpha character namely pinkie=A, ring finger=B, middle finger 28=C, index finger=D, thumb=E and for the right hand 26 namely thumb=F, index finger=G, middle finger 30=H, ring finger=I and thumb=J.

These specifically designed or manufactured parts 32, then require alpha characters from A-J to be embossed or etched onto the 10 finger rings. On completion the student then places each finger ring 34 on the correct fingers according to FIG. 4 and using the whole teaching device for piano or keyboard, comprising of numerically embossed or etched keys of an instrument 16, a finger ring configuration device 22 and specific music sheets 18, the child or adult learns an instrument independently of others.

The Morpheus Notation System of this invention enables children, adults, elderly & the blind to learn a musical instrument in a revolutionary way, where all the notes are arranged in a simplistic method. There is no condition to learn traditional musical theory to use the teaching device. A person learns the instrument in a non-complex way where the idea can be applied to the absolute variety of worldwide instruments across the music spectrum.

With regard to the concept behind the butterfly effect mentioned in parent application Ser. No. U.S. 11/016,438 humans unconsciously look to the top of any reading material given to them. It's an automatic response that is learned at a primary age where we read ‘the black board from the top-down. The symbols of traditional music notation are replaced with the exact numeric values of the 88 notes on a classical piano. The piano is the base instrument of all musical instruments where the A0 (first note) and C8 (last note) cover the frequency range of all musical instruments. This concept device can then be transferred to the development of devices and music sheet notation for all other instruments. The Alphabet & Numbers create a simple environment, which opens the music creativity window.

### Solution to Problems of Prior Art Music Notation.

As well as the solutions outlined in Parent application Ser. No. U.S. 11/016,438 braille systems can be applied to each type of technique for various instruments, where the notation adapts to the instrument, not the traditional way that instruments adapt to the notation. New instruments that are invented will be immediately adaptable to the notation as the structure sees it, the boundaries are infinity. Because the idea is numbers & alphabetically based it will be easy for instrument manufacturers to apply Braille or non-Braille characters i.e. A, B, C, D, F, G, H, I and J for the finger ring configuration device and also the numeric values of 1-88 embossed or etched onto the keys of the specific instrument device.

Every type of instrument i.e., Key, String, Wind, Percussion, etc., will have a different device and method, which will make it simple for music publishers to print books and music sheets specifically for playing exclusive instruments like clarinets and flute to name a couple. The student can comprehend it instantly and not spend years learning the theory of traditional music notation.

### Development of Morpheus Notation for Music Publishers.

a) Stage I: Traditional sheet music obtained along with the disc for the piece of music.

b) Stage II: Transfer all traditional notation into the specific keys on the classical piano 10 i.e., whether note is C5=52 or a D5=53 on the classical piano 12.

c) Stage III: Use the full 88 note classical piano layout 10 to label, emboss or etch the exact number 16 onto the specific keys of the piano using a laser or other technical process.

d) Stage IV: The Morpheus Notation Music Sheet is created transcribing the full piece of music, where the artist takes into account the specific keys i.e., numeric values from 1-88 that are being played and also with which digit of the fingers of the hands using the finger ring configuration device 22.

e) Stage VI: The person who reads the music uses the teaching device comprising of 10 finger rings 32 labelled, embossed or etched with alpha characters namely A, B, C, D, E, F, G, H, I and J, which are then placed onto each corresponding designated finger of the hands and also the specially embossed keyed instrument 14 with values not limited between 1-88. The user then using the device and new music sheet 18 can play the correct keys on the instrument, with the correct finger co-ordination as stipulated by the teaching device and listens to the how the music is played, with the optional grid being applied to the music sheet for difficult pieces of music.

Every type of instrument i.e., Key, String, Wind, Percussion, etc., will have a different device and method, which will make it simple for music publishers to print books and music sheets specifically for playing exclusive instruments like clarinets and flute to name a couple. The student can comprehend it instantly and not spend years learning the theory of traditional music notation.

### Development of Morpheus Notation for Music Publishers.

a) Stage I: Traditional sheet music obtained along with the disc for the piece of music.

b) Stage II: Transfer all traditional notation into the specific keys on the classical piano 10 i.e., whether note is C5=52 or a D5=53 on the classical piano 12.

c) Stage III: Use the full 88 note classical piano layout 10 to label, emboss or etch the exact number 16 onto the specific keys of the piano using a laser or other technical process.

d) Stage IV: The Morpheus Notation Music Sheet is created transcribing the full piece of music, where the artist takes into account the specific keys i.e., numeric values from 1-88 that are being played and also with which digit of the fingers of the hands using the finger ring configuration device 22.

e) Stage VI: The person who reads the music uses the teaching device comprising of 10 finger rings 32 labelled, embossed or etched with alpha characters namely A, B, C, D, E, F, G, H, I and J, which are then placed onto each corresponding designated finger of the hands and also the specially embossed keyed instrument 14 with values not limited between 1-88. The user then using the device and new music sheet 18 can play the correct keys on the instrument, with the correct finger co-ordination as stipulated by the teaching device and listens to the how the music is played, with the optional grid being applied to the music sheet for difficult pieces of music.

As can be gleaned from FIG. 10 (Same as FIG. 5 of Parent application Ser. No. U.S. 11/016,438. This Flowchart delineates the different techniques applicable for the Morpheus Music Notation System to the list of instruments as mentioned above is further explained as follows:

a) Morpheus Keyed Notation I (110)

b) Morpheus Keyed Notation II (112)

c) Morpheus Keyed Notation III (114)

d) Morpheus String/Fret Notation (120)

e) Morpheus String/Non-Fret Notation (122)

f) Morpheus String Plucked Notation (124)

g) Morpheus Wind Notation I (130)

h) Morpheus Wind Notation II (132)

i) Morpheus Percussion Notation (140)

### Morpheus keyed notation (I)

Reference: Pianos, Keyboards, Organs, Harpsichords, Clavichords, Pianofortes, Pipe Organs & Synthesizers. Using the descriptive method outlined for this section within the Parent application Ser. No. U.S. 11/016,438 the following device is created to teach a user how to play this type of instrument. The Finger Ring Configuration Device is developed whereby the alpha characters A, B, C, D, E, F, G, H, I and J are assigned to each finger ring of each hand as detailed in FIG. 5. These finger rings are then labelled, embossed or etched with the alpha characters A-J, which are then placed in correct order on the students fingers. Each key of the specific piano, keyboard or organ are labelled, embossed or etched with their exact numeric value from 1-88 according to their frequency from the classical piano layout in FIG. 1 thus creating a new teaching instrument device. The Morpheus Music Sheet is then used where the values of each device are applied to the structure within the new music sheet. Thus, any individual can clearly follow the playing of this type of music instrument using the device(s) described.

With reference to Pipe Organs which contain several keyboard and pedal boards each are assigned specific alpha & numeric values which are then embossed or etched onto the relevant key or pedal to instruct a user which parts of the instrument is to be played.

### Morpheus Keyed Notation (II)

Reference: Dulcimers, Vibraphones, Xylophones, and Cimbaloms. Within this technique a music notation sheet is created where the above list of instruments is to be represented on two separated lines on a staff. Each line indicating a row of wooden blocks (xylophones); strings (dulcimers, cimbaloms); metal bars (vibraphones) which are laid out. Both hands use hammers independently or in unison to strike the wooden blocks for example: xylophones. So an additional row of wooden blocks would be represented by another line within the staff to indicate a third or more supplementary rows of wooden blocks. Each wooden block in the xylophone example is assigned a numeric value using the classical piano layout or letter of which is then embossed or etched by a technical process like a laser or carving process onto each specific block. This specific value is then placed on the relevant line on the staff to indicate the correct wooden block to strike within the correct row of blocks. This enables a novice to strike the correct wooden block, string, and metal bar within the correct row of wooden blocks, strings & metal bars. An advancement of this idea could also lead to a letter or number being assigned to both hands. So A=Left Hand & B=Right Hand where this letter is then placed beside the numeric value on the line within the staff, which would then help even further so a novel person would know which hand to use to strike the wooden blocks, strings, metal bars. The wooden block is used only as an example, so the idea also applies to Dulcimers, Vibraphones & Cimbaloms. In all cases within the technique the first/top line on the staff indicates the uppermost row of strikable blocks etc which makes it simple for a novel person to read as in the Butterfly Effect on how people view reading material i.e., top to bottom.

### Morpheus Keyed Notation (III)

Reference: Button & Piano Accordions or similar instruments. Within this technique a music notation sheet and specific teaching device are created where the above list of instruments is to be represented on two separate clefs where the right side (melody) of the accordion or similar instrument and its relevant note/keys/buttons are indicated by the exact numeric value of this note. These values are then embossed or etched onto the instrument to indicate to the user the relevance of where they are playing from within the music spectrum. It relates to where the note is represented by the layout of the classical piano as explained in Morpheus Keyed Notation (I). Accordions are arranged in categories according to the amount of buttons they contain on the left side (accompaniment). 12 bass (=12 buttons) and all the way up to 120 bass (=120 buttons). To explain the idea further the 120 bass will be used as an example. Because the left side (accompaniment) of the accordion is relatively different in its layout to the right side (melody) the second clef would contain 6 lines i.e., 6 rows of buttons available on left side of the 120 bass accordion and each row contains 20 depressible buttons (20×6=120). Each button within each row is assigned a letter or numeric value for example 1-20 which is then embossed or etched onto the instrument. This numeric value is then placed on the relevant line on the clef where the innermost row of buttons is referenced to the uppermost line on the clef and outermost row of buttons is the bottom line on the clef. This again is using the Butterfly Effect in how people view reading material but the reverse of how the buttons are represented on the clef is also true. This enables a novel person to view the correct button/key on the correct row of buttons on the accompaniment side and the correct note/key on the melody side with the correct finger configuration using the finger ring device designation of namely alpha characters F, G, H, I and J as used in the Rama (Right Hand) Clef in Morpheus Keyed Notation (I).

An advancement of this idea comprises fingers rings for the left hand are labelled, embossed or etched with the letters or numbers i.e., A, B, C, D, E in consecutive order and then this letter is placed beside the numeric value on the Left (Accompaniment) Clef within the music sheet, thus a novel person would then know which finger to use to play the buttons on the Left side of the accordion.

### Morpheus String/Fret Notation

Reference: Guitars (1-12 Strings), Mandolins, Banjos, and Sitars. Within this technique a music notation sheet along with a specific teaching device are created where the above list of instruments is to be represented on a stave or staff of 1-12 lines which is directly proportional to the amount of strings the instrument has.

The numeric value of the fret is placed on the relevant line on the staff in relation to the specific string. Each technique is to be developed where the top line on the staff represents the specific string that a novel person sees when looking down on the instrument while being held as in the Butterfly Effect.

This idea creates the top-bottom view of reading material. Each finger ring which makes up the Morpheus Finger Ring Configuration Device is labelled, embossed or etched with a letter or number i.e., A, B, C, D, E, F, G, H, I, J in consecutive order and then this letter is placed beside the numeric value of the fret.

This enables a novice person to pick up a fretted stringed instrument for the first time and using the music sheet created reads the sheet from top-down so the uppermost line on the staff is the top string they see when looking down on the instrument, the numeric value of the fret informing the novel person of the correct fret and the letter as assigned in the Morpheus Finger Ring Configuration Device configuration informs them of the correct finger to use to play the fret.

### Morpheus String/Non-Fret Notation

Reference: Cellos, Violins, Violas, Double Bass, and Fiddles. Within this technique a music notation sheet and teaching device are created where the above list of instruments is to be represented on one clef and the amount of lines within the clef is directly related to the quantity of strings on each of the above mentioned non-fret instruments. As an example the violin contains four strings thus it is represented on a staff of four lines. Each note within the scale of each string on the violin is assigned the exact numeric value it relates to on how the note sounds on a classical piano layout. This numeric value is then placed on the line indicating the relevant string and using the aforementioned Morpheus Finger Ring Configuration Device the alpha characters of A, B, C, D, E, F, G, H, I, J are placed beside the numeric value within the staff lines. A compact disc or cassette is then produced with the complete scale of each string and how it should correctly sound, as is the difficulty in playing non-fretted instruments. The author of the compact disc or cassette for example would quote “40” i.e., which is the 40^{th} key on the classical piano and this tone is then played from the violin. These kinds of instruments are played with a bow in order to make the tone or sound from the violin so the breathing movements used in Morpheus Wind Notation (II) could be applied here where an analogy of the bow movement could be related to breathing movements where <=inhale: the bow is pushed over the strings of the violin to the left and >=exhale: the bow is pushed over the strings of the violin to the right. These two symbols “<, >” could be placed either above the numeric value or above the staff to indicate bow movement over the strings of the instrument. Sometimes the fingers are used to pluck the strings of the violin, so the symbols would not be placed above the numeric value thus informing the novel person not to use the bow to play the specific note. In all ideas for the technique the Butterfly Effect is used in how the staff lines are structured in that when a person holds the violin the left hand is spread across the strings from right to left so the string to the right of the instrument i.e., “G” is the uppermost line on the staff.

Using all the embodiments detailed above this would enable a novel person to play the correct note with the correct finger configuration and correct bow movement.

### Morpheus String/Plucked Notation

Reference: Harps or similar instruments. Within this technique a music notation sheet and teaching device are created where the above list of instruments is to be represented on the previously mentioned Leda (Left Hand) & Rama (Right Hand) Clefs as used in Morpheus Keyed Notation (I) because the Harp is an instrument that is played with both hands as are keyboard instruments. Each of the two clefs within the staff would contain as before five lines each.

The aforementioned Finger Ring Configuration Device of labelling, embossing or etching the fingers rings of each hand with letters or numbers i.e., A, B, C, D, E, F, G, H, I, J and the use of the Butterfly Effect in relation to how these letters relate to each clef is applicable. Many harps have a range of about two octaves or more but the exact numeric value the string relates to on the classical piano layout is used which is then embossed or etched onto the instrument, preferably above each string.

This numeric value is then placed on the relevant line of each staff in reference to finger configuration used to play the specific string on the harp. This enables a novel person to see using the music sheet the correct string to be played and with the correct finger by means of the finger ring teaching device. An advancement of the technique could display an idea whereby the upper, middle and lower part of the harp are named with any letters for example: U=Upper M=Middle, L=Lower respectively or with numbers. These letters or numbers are then placed beside the numeric value of the note on the line within the staff because the harp can produce different harmonics on different areas of the string. This would help a novel person to play the correct numeric value on the correct area of the specific string.

Any numbers or letters could be used to display the idea where the harp could be split into several sections to indicate a specific area on the string. Another advancement on the technique could be where the breathing movements as used in Morpheus Wind Notation (II) could be applicable i.e., <=inhale: string is plucked toward the body and >=exhale: string is plucked away from the body. These symbols “< or >” are then placed above the numeric value or above the staff so a novel person would be able to see which direction the strings of the harp are being plucked. Other use of several different symbols could be used to indicate same.

### Morpheus Wind Notation (I)

Reference: Recorders, Flutes, Tin Whistles, Piccolos. Within this technique a music notation sheet and teaching device are created where the above list of instruments is to be represented on one clef and the quantity of lines on the staff is directly related to the amount of holes on the instrument covered by the fingers of each hand. So for example a tin whistle has six holes so the clef would have six lines and the tin whistle would have a numeric value from 1-6 embossed, etched or labelled beside each relevant hole on the instrument. Another single line is then added to the staff separate from the other six lines. The note played on the tin whistle is directly related to the exact numeric value it represents on the classical piano layout. This numeric value is then placed on the single line and the finger ring configuration device idea where the fingers rings for each hand are labelled, embossed or etched with letters or numbers i.e., A, B, C, D, E, F, G, H, I, J. The relevant letter in what fingers are covering the holes are then placed on the relevant line where the top line on the staff represents the uppermost hole on the tin whistle when looking down on the instrument when playing it. This enables a novel person to see what hole is being covered, with which fingers. An advancement of this technique could also include the breathing movements used in Morpheus Wind Notation (II) i.e., <=inhale and >=exhale.

These symbols are then placed above the numeric value or above the staff to indicate the breathing movement involved in playing the note on the tin whistle. The clef could be separated by three lines each indicating the upper three holes on the tin whistle and the lower three holes on the tin whistle, but ideally the 6 lines should be on the clef together.

### Morpheus Wind Notation (II)

Reference: Clarinets, Bassoons, Bagpipes, Saxophones, Trumpets, French Horns, Trombones, Baritone Horns, Oboes, and Tubas. Within this technique a music notation sheet and teaching device are created where the above list of instruments is to be represented on two separate clefs as displayed in FIG. 4 of Parent application Ser. No. U.S. 11/016,438 and within the staff and the amount of lines in each clef is directly proportional to the amount of depressible valves/keys or buttons on the instrument and the clef is split in two where one represents the left hand (upper clef) and the other for the right hand (lower clef).

As an example a Clarinet would contain a staff of two clefs each clef containing twelve lines each i.e., the clarinet has twenty four depressible keys, through common knowledge of clarinets we know that twelve of them are depressed with the left hand and the other twelve are depressed with the right hand. These exact numeric values are then embossed, etched or labelled onto the instrument preferably beside or on each key or valve.

Finally an additional single line is placed below the two clefs where the exact numeric value of the note on the clarinet represents the specific key on the classical piano layout. The twenty four keys of the clarinet are labelled 1-12 (left hand) and 1-12 (right hand) or 1-24 and the finger configuration where the fingers rings for each hand are named with letters or numbers i.e., A, B, C, D, E, F, G, H, I, J is used. The letters are then placed on the line that relates to the specifically depressed key on the clarinet.

This enables a novice (student of music) see what numeric value they are playing with reference to the classical piano, what keys are being depressed on the instrument and with the correct finger configuration using the finger ring configuration device. As before the advancement on the technique could also include breathing movements i.e. <=inhale and >=exhale, where the symbols are placed above the numeric value or above the staff to indicate breathing movements involved in playing the numeric value i.e., note on the clarinet. The clarinet is used as an example but the idea applies to all the above referenced instruments.

### (4A)-Morpheus Percussion Notation

Reference: Standard Non-Artificial Drum Kit referred to as (DK1) & the Artificial Synthesized Drum Kit referred to as (DK2). Within this technique a music notation sheet and teaching device are created where the above DK1 & DK2 are represented on a staff of six lines. Three lines are used to identify DK1 which should be heavier line font style compared with the three lines used to represent DK2.

The six lines are just a guide and keeps the staff slender and easy to read, but more lines could be used, but ideally six lines is more than enough for both DK1 & DK2 to be represented on. DK1 refers to a non-artificial Drum Kit containing seventeen different percussive sounds that are available on standard drum kits that include a snare, hi-hat, cymbals to name a few. DK2 refers to an artificial Drum Kit containing a list of the many synthesized percussive sounds available on synthesizers of today. These two Drum Kits are represented on the full clef containing six lines or independently where for example a standard drummer would only need the notation sheet for the DK1 i.e., three lines, or vice versa in regards to DK2.

On the three lower lines a list of seventeen various percussive sounds are assigned a number or letter i.e., 1-17 in no particular order of which are embossed or etched onto the relevant percussive instrument. These numbers are then placed on any of the three lower lines.

This enables a novice (person) to see using the music sheet what percussive sound is being played and the timing involved using a structure involving bars of music in the form of a grid when exactly these sounds are played. On the upper three lines a list of available percussive sounds synthetically created using a synthesizer are assigned a number or letter. These numbers or letters i.e., 18-400 are then placed on any of the upper three lines.

These numeric values unlike previous embossed values onto instruments cannot be repeated here, as these sounds are in virtual or non-physical form i.e., they are inside the instruments such as a synthesizer. However, this statement is not limited to this criterion if the values were created in physical form i.e., outside the instrument, like a snare drum for example.

This enables even a novice person to see what sound is being played and using bars of music in the form of a grid when the sound is being played. An advancement of this technique could also display how the sounds are related within the stereo field especially applicable to DK2. For example a letter or number L=Left, C=Centre, R=Right. This letter is then placed beside the assigned number within the clef where this identifies to a novel person using the music sheet where the sound is originating from within the stereo field. Ideally an international standard list of synthetic percussive sounds from synthesizers could be created, much like the worldwide list of GM Sounds in relation to MIDI (Musical Instrument Digital Interface) that were created many years ago as a set standard for GM sounds. This would lead to international music notation books being printed under a set standard.

In all the above three examples of Morpheus Keyed Notation (I), Morpheus Keyed Notation (II) and Morpheus Keyed Notation (III) a new and novel music sheet for chord representation can be created using the embodiments of the Morpheus Music Notation System devices and method as shown in FIGS. 6-9. The chord structural display for Keyed instruments is referred to as the Morpheus Chord Chart for Keyed Instrument as displayed in FIG. 7.

In the above three examples of Morpheus String/Fret Notation, Morpheus String/Non-Fret Notation and Morpheus String/Plucked Notation a new and novel music sheet for chord representation can be created using the embodiments of the Morpheus Music Notation System devices and method. The chord structural display for String instruments will be referred to as the Morpheus Chord Chart for String Instrument as displayed in FIG. 9.

In FIG. 6 a conventional chord diagram 52 is shown that is currently the standard in books for learning chords with Keyboard instruments. For every chord diagram an octave of keys is displayed 54, which is inconvenient to a user who wishes to create their own chord charts. It is also not possible for the conventional chart to show both hand chord diagrams in combination with each other i.e., Left Hand and Right Hand, unless some sort of octave prefix is used to separate the two chords.

In FIG. 7 what is put forward is a new and novel chord chart called the Morpheus Chord Chart for Keyed Instrument 56, where the user sees instantly which finger co-ordination 58 using the Finger Ring Configuration Device 22, to play specific notes within a specific chord anywhere on the keyboard instrument, while also displaying both hand chord structures 60 in combination.

In FIG. 8 a conventional chord diagram 62 is shown that is currently the standard in books for learning chords with String instruments. The diagram displays the 6 strings of a standard guitar in succession from a Low E String, A String, D String, G String, B string 64 and the High E String. The amount of frets is also represented 66, where the chord diagrams are limited to 5-6 frets on a guitar at any one time. What occurs thereafter are numeric fret prefixes indicating a specific part of the guitar, which appears above the chord diagram. Then the student counts down the rest of the frets to identify the location of subsequent frets.

The fret to be depressed by the user on which string of the guitar is displayed 68 as a dot within the diagram. However the disadvantage of this method is that the user does not see the finger co-ordination that is involved to play the chords.

In FIG. 9 what is put forward is a new and novel chord chart called the Morpheus Chord Chart for String Instrument 70. All information that is required by a user to play the chord is displayed i.e., correct fret 74, correct string 76, correct Finger Co-ordination 78 using the Finger Ring Configuration Device 22 without the need for any prefixes to separate frets to indicate specific chord diagrams on higher regions on the instrument.

So for example within FIG. 9, it shows that on the A string within the Chord structure the 2^{nd} Fret is to be depressed on the instrument 74 with the index finger of the Left Hand. The advantages to both types of Chord Charts are limitless where, two-handed combination Chord Charts can be displayed to a musician in a non-complex manner, leaving the student to expand on their own ability.

A contemplated enhancement on the string method comprises, wherein instead of the left hand being used to hold down particular frets on a string instrument, the chord chart could evolve whereby the right hand could be used to depress certain frets on the instrument in the case of two hand tapping techniques.

All that is required is that the alpha characters used in the Finger Ring Configuration Device for the right hand i.e., F, G, H, I and J could be placed beside the fret/string indicators to show specific frets not depressed by the left hand. Further change would be an extra column to support the 5^{th} finger of the left hand for the blind, where to help with location on the instrument, the instrument is laid flat upon the knees which would leave the dexterity of the thumb being used in this position.

Also, Chord Charts for Left Handed players could be manufactured, where instead of the alpha characters 78 for the left hand being displayed, these could be replaced with the alpha characters for the right hand using the Finger Ring Configuration Device 22.

As can be gleaned from the accompanying drawing FIG. 10 the Flowchart delineates the different techniques applicable for the Morpheus Music Notation System to the list of instruments as mentioned above is further explained as follows:

j) Morpheus Keyed Notation I (110)

k) Morpheus Keyed Notation II (112)

l) Morpheus Keyed Notation III (114)

m) Morpheus String/Fret Notation (120)

n) Morpheus String/Non-Fret Notation (122)

o) Morpheus String Plucked Notation (124)

p) Morpheus Wind Notation I (130)

q) Morpheus Wind Notation II (132)

r) Morpheus Percussion Notation (140)

### Advantages of Morpheus Notation

The advantages of this type of notation and teaching device are endless. No requirement for musical theory, the technique is adaptable to suit any instrument, with each teaching device manufactured having as its fundamental original concept the classical piano layout. This device origin is always used to form each type of technique and mechanical teaching device. The window of creativity is opened on a profound level where boundaries have not been set which in turn gives the freedom to experiment. However the one important breakthrough is that the blind will be able to learn any instrument with the use of this notation system and teaching device. Braille or non-braille values can be inducted into the Anubis Tree, which indicates the numbers and beats within the bar. Braille numbers or non-braille values can also be applied to the instrument with set guidelines on how to produce these sets of numbers. Children once shown the method on how to use the specific teaching device will not need the presence of an adult or tutor and more people will begin to learn instruments because of the simplicity of the idea and independence from tutors and teachers.

In all the above techniques and devices mentioned the central idea where a tone or key on a classical piano is embossed or etched by a technical process such as laser or material carving with its direct numeric value between 1-88 on the classical piano layout and this numeric value is then placed on the relevant staff is crucial to the structure of Morpheus Music Notation System. The idea of using the specific finger ring designation device to identify the lines on each of the clefs is an ideal way of creating s simple structure for music. One could also place the key value on the relevant staff i.e. instead of the numeric value of “40”, “C4” or “C” is placed on the relevant staff, but in order for the idea to be developed across all the above instruments a set of numbers for the notes and assigned letters for the finger ring configuration device enables the teaching structure to be created within a simple environment where you are not mixing letters with letters or numbers with numbers and the Butterfly Effect in how people view reading material is applicable.

The numeric value on the classical piano could also be any set of consecutive or alternate numbers, letters, range of values which could be used instead of the above mentioned 1-88 and A, B, C, D, E, F, G, H, I, J. These values could also be placed on the spaces within the lines of each staff in each case, but having them on the line creates a simple structure to be viewed in a solid manner by a novel person for the first time. Any particular order could be involved in naming the finger ring configuration device with letters or numbers or other forms of labelling, but by naming them in consecutive order from left hand pinkie to the right hand pinkie when these letters are applied to the staff the butterfly effect in how people from primary age read books from left to right and top-bottom is an ideal way to create the notation system.

In all the above cases the idea in how each clef is separated within each technique is a structure created specifically to enable a novel person to view a music sheet within a simple structure, but these clefs could be all joined together intermittently in any form, but doing this would render the structures difficult to read, thus the need for the separation of the clefs.

Where the clefs are separated, one could also separate the clefs even more as is the example mentioned where the clef for DK1 & DK2 could be separated and viewed on a music sheet independently as just three lines for DK1 or another music sheet with three lines for DK2. The whole idea however revolves around separating the clefs to identify the use of the left hand independently from the right hand.

Each technique has a grid of vertical lines placed over the clefs to identify bars in music. You could also have for example in Morpheus Keyed Notation (I) where just one staff is used on the music notation sheet given to the novel person to identify the notes only with a particular hand. This design is pointless as there are not many instruments that are always just played with one hand. However if there were a case for instance where a novice had the loss of one of his or her limbs, well then this design would be adaptable in order for that person to enjoy playing music with just the one limb.

The whole idea the inventor envisages behind the Morpheus Music Notation System is that everyone has the right to learn a musical instrument, so just because a person has a certain handicap in their being should not prevent them from learning an instrument because the design of the teaching device and structure of the notation system is adaptable to everyone's needs.

Following is a listing of the components used in the best mode preferred embodiment and the alternate embodiments for use with OEM as well as retrofit markets. For the ready reference of the reader the reference numerals have been arranged in ascending numerical order.
010=Piano Keyboard Layout
012=Numeric Value of Musical Note on Keyboard for example 61=A5 on Piano Keyboard
014=Instrument Teaching Device
016=Embossed/Etched Values onto Instrument Teaching Device
018=Morpheus Notation Music Sheet
020=Numeric value of note on instrument device shows placement on Clef vis-à-vis finger configuration
022=Finger Ring Configuration Device
024=Left Hand
026=Right Hand
028=Middle Finger of Left Hand
030=Middle Finger of Right Hand
032=Specific Manufactured Finger Rings
034=Finger Ring for Pinkie Finger of Right Hand
040=Clarinet
042=Back of Clarinet
044=Displays how the 24 depressible keys on a clarinet are separated where the amount of keys on the instrument are referenced to another clef within the staff containing 12 lines indicating keys to be played with the left hand
046=Displays how the 24 depressible keys on a clarinet are separated where the amount of keys on the instrument are referenced to another clef within the staff containing 12 lines indicating keys to be played with the right hand
048=Each depressible key, valve, button on the instrument within morpheus wind notation (II) 132 is assigned consecutive or alternate numbers or letters in this case from 1-24, but it can also be 1-12 for the left hand keys and 1-12 for the right hand keys
050=Each of these specifically assigned values to these depressible key, valve, button on the instrument 48 are then embossed or etched onto the keys, valves of the relevant instrument.
052=Conventional Chord Chart for Key Instrument
054=A specific amount of Keys to be displayed within the Chart
056=Morpheus Chord Chart for Key Instruments
058=Fingers to be used to play the keys of instrument using the Finger Ring Configuration Device
060=Numeric value on keyed instrument using the Classical Piano Layout within the Morpheus Music Notation System.
062=Conventional Chord Chart for string Instrument
064=Indication of B string on Conventional Chord Chart
066=Indication of 2^{nd} Fret on Conventional Chord Chart
068=Specific Fret to be depressed by user using the Conventional Chord Chart
070=Morpheus Chord Chart for String Instruments
074=Indication of 2^{nd} Fret on A string using Morpheus Chord Chart for String Instrument
076=Indication of string D using Morpheus Chord Chart for string Instrument
078=Fingers to be used to play the frets of instrument using the Finger Ring Configuration Device
100=Top Down Morpheus notation system generally
110=Morpheus Keyed notation I
111=Key instruments generally
112=Morpheus Keyed notation II
113=Dulcimers, Vibraphones, Xylophones, Cimbaloms & the like
114=Morpheus Keyed notation III
115=Accordions
120=Morpheus String/Fret Notation
121=Guitars (1-12 strings) Mandolins, Banjos, Sitars the like
122=Morpheus String/Non-Fret Notation
123=Cellos, Violins, Violas, Double Bass, Fiddles and the like
124=Morpheus string/plucked notation
125=Harps
130=Morpheus Wind Notation I
131=Recorders, Flutes, Tin Whistles, Piccolos and the like
132=Morpheus Wind Notation H
133=Clarinets, Bassoons, Bagpipes, Saxophones, Trumpets, Oboes, French Horns, Trombones, Baritone Horns, Tubas and the like instruments.
140=Morpheus Percussion Notation
142=Standard Non-Artificial Drum Kit (DK1) and Artificial Synthesized Drum Kit (DK2)

### DEFINITIONS AND ACRONYMS

A great care has been taken to use words with their conventional dictionary definitions. Following definitions are included here for clarification.

Anubis=A tree like structure that integrates morpheus notation with prior art notation for easy transition

DK1=Standard Non-Artificial Drum Kit

DK2=Artificial Synthesized Drum Kit

Integration=Fusing or joining together to become as one unitary member

Interface=Junction between two dissimilar but optionally matching entities

Morpheus=Two hands independent of each other with global approach all human audio range musical instruments including key, string, wind and percussion and permutations and combinations thereof.

Stave/Staff=A set of n (usually 5) horizontal lines with corresponding (n−1) usually 4 spaces between them on which music is written.

The reader can now readily see how the above detailed description results in the following benefits of the invention over the prior art.

a) User Friendly self teaching of any musical instrument
b) Suitable for people of all ages and gender in all types of situations.
c) Multiple uses in a wide range of situations and circumstances.
d) Easily adaptable for other uses.
e) Intuitive top down butterfly morpheus music notation system

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within the true scope of this invention.

The Inventor claims:

1. A top down butterfly morpheus music notation system learning and teaching device for ease of learning to play a musical instrument comprising:
a) a butterfly morpheus music instrument with plurality of manual input means each with a first unique visible indicia;
b) a plurality of ring fingers each with a second unique visible indicia; and
c) a custom butterfly morpheus music notation sheet comprising a plurality of bars, staves, scales, keys chords, notes frequencies customized to said music instrument and said ring fingers.

2. The top down butterfly morpheus music notation system learning and teaching device of claim 1 wherein:
a) said music instrument is a piano;
b) said input means comprises keys;
c) said first visible indicia is numeric;
d) said plurality of ring fingers are ten; and
e) said second visible indicia are alpha.

3. The top down butterfly morpheus music notation system learning and teaching device of claim 2 wherein:
a) said keys are 88;
b) said first visible indicia comprises 1 thru 88 consecutively numbered from left to right; and
c) said second unique visible indicia comprise A thru J.

4. The top down butterfly morpheus music notation system learning and teaching device of claim 3 wherein said second visible indicia on said ring fingers are:
a) A on left hand little pinkie finger ring;
b) B on left hand ring finger ring;
c) C on left hand middle finger ring;
d) D on left hand index finger ring;
e) E on left hand thumb ring;
f) F on right hand thumb ring;
g) G on right hand index finger ring;
h) H on right hand middle finger ring;
i) I on right hand ring finger ring; and
j) J on right hand little pinkie finger ring.

5. The top down butterfly morpheus music notation system learning and teaching device of claim 1 wherein said music instrument is a keyed instrument selected from the group consisting of pianos, keyboards, organs, harpsichords, clavichords, pianofortes, pipe organs and synthesizers.

6. The top down butterfly morpheus music notation system learning and teaching device of claim 1 wherein said music instrument is a keyed instrument selected from the group consisting of Dulcimers, vibraphones, xylophones and cimbaloms.

7. The top down butterfly morpheus music notation system learning and teaching device of claim 1 wherein said music instrument is a button accordion.

8. The top down butterfly morpheus music notation system learning and teaching device of claim 1 wherein said music instrument is a piano accordion.

9. The top down butterfly morpheus music notation system learning and teaching device of claim 1 wherein said music instrument is a fret string instrument selected from the group consisting of guitars, mandolins, banjos and sitars.

10. The top down butterfly morpheus music notation system learning and teaching device of claim 1 wherein said music instrument is a non-fret string instrument selected from the group consisting of cellos, violins, violas, double bass and fiddles.

11. The top down butterfly morpheus music notation system learning and teaching device of claim 1 wherein said music instrument is morpheus string plucked instrument.

12. The top down butterfly morpheus music notation system learning and teaching device of claim 11 wherein said morpheus string plucked instrument is a harp.

13. The top down butterfly morpheus music notation system learning and teaching device of claim 1 wherein said music instrument is a wind instrument selected from group consisting of recorders, flutes, tin whistles and piccolos.

14. The top down butterfly morpheus music notation system learning and teaching device of claim 1 wherein said music instrument is a wind instrument selected from group consisting of clarinets, bassoons, bagpipes, saxophones, trumpets, French horns, trombones, baritone horns, oboes, and tubas.

15. The top down butterfly morpheus music notation system learning and teaching device of claim 1 wherein said music instrument is a percussion instrument.

16. The top down butterfly morpheus music notation system learning and teaching device of claim 15 wherein said percussion instrument is a standard non-artificial drum kit.

17. The top down butterfly morpheus music notation system learning and teaching device of claim 15 wherein said percussion instrument is an artificial drum kit.

18. A top down butterfly morpheus music notation system piano for ease of learning and teaching the playing of said piano comprising:
a) 88 keys consecutively visibly numbered 1-88 left to right;
b) a plurality of ring fingers each with a unique visible indicia; and
c) a custom butterfly morpheus music notation sheet comprising a plurality of bars, staves, scales, keys chords, notes frequencies customized to said piano and said ring fingers.

19. A top down butterfly morpheus music notation system piano of claim 18 wherein said plurality of ring fingers are ten and said visible unique indicia is alpha.

20. The top down butterfly morpheus music notation system piano of claim 18 wherein said unique visible alpha indicia on said ring fingers are “A” on left hand little pinkie finger ring, “B” on left hand ring finger ring, “C” on left hand middle finger ring, “D” on left hand index finger ring, “E” on left hand thumb ring, “F” on right hand thumb ring, “G” on right hand index finger ring, “H” on right hand middle finger ring, “I” on right hand ring finger ring and “J” on right hand little pinkie finger ring.
